(19) United States
(12) Patent Application Publication
(10) Pub. No.: US 2026/0321799 A1
(43) Pub. Date: Oct. 15, 2026

(54) HIGH TEMPERATURE RESISTANT INSULATING FILM

(71) Applicant: Illinois Tool Works Inc., Glenview, IL (US)

(72) Inventor: Run SU, Shanghai (CN)

(21) Appl. No.: 19/119,139

(22) PCT Filed: Oct. 10, 2023
(86) PCT No.: PCT/US2023/076458

§ 371 Date: Apr. 8, 2025

(30) Foreign Application Priority Data
Oct. 11, 2022 (CN) 202211241696.8
Oct. 11, 2022 (CN) 202222677854.6
Aug. 25, 2023 (CN) 202322293116.6

(51) Int. Cl. H01M 10/658; B32B 7/12; B32B 9/04; B32B 27/32; B32B 27/36

(52) U.S. Cl. CPC H01M 10/658; B32B 7/12; B32B 9/045; B32B 27/32; B32B 27/36; B32B 2255/26; B32B 2307/304; B32B 2307/7376; B32B 2457/10

(57) ABSTRACT

The present application discloses a high-temperature-resistant insulating film comprising an upper additional layer, a mica layer, and a lower additional layer. The high-temperature-resistant insulating film not only possesses excellent high-temperature resistance, superior mechanical performance, and exceptional insulation performance but also has significantly lower costs compared to conventional plastic films.

### RELATED APPLICATIONS

This international application claims priority to Chinese Patent Application No. 202211241696.8, filed Oct. 11, 2022, to Chinese Patent Application No. 202222677854.6, filed Oct. 11, 2022, and to Chinese Patent Application No. 20232293116.6, filed Aug. 25, 2023. The entireties of Chinese Patent Application No. 202211241696.8, Chinese Patent Application No. 202222677854.6, and Chinese Patent Application No. 20232293116.6 are incorporated herein by reference.

### TECHNICAL FIELD

The present application relates to the field of films, in particular to a high-temperature-resistant insulating film.

### BACKGROUND

Insulation films are used to isolate various electronic devices or components to prevent failures caused by short circuits, breakdowns, etc., between or within electronic devices or components. Some insulating films also need to have high-temperature resistance to reduce the impact of localized high temperatures on electronic devices or components, ensuring the normal operation of various electronic devices or components.

### SUMMARY

The object of the present application is to provide a high-temperature-resistant insulating film for use in electronic devices or components, which meets the insulating requirements of electronic devices or components while also possessing excellent high-temperature resistance. Additionally, this high-temperature-resistant insulating film possesses excellent mechanical performance to meet the requirements of the usage environment.

A first aspect of the present application provides a high-temperature-resistant insulating film comprising: an upper additional layer; a mica layer; and a lower additional layer; in which the outer surface of the upper additional layer forms a first outer surface of the high-temperature-resistant insulating film, the inner surface of the upper additional layer is attached to the upper surface of the mica layer; and in which the inner surface of the lower additional layer is attached to the lower surface of the mica layer, the outer surface of the lower additional layer forms a second outer surface of the high-temperature-resistant insulating film.

According to the first aspect above, the upper additional layer is directly attached to the upper surface of the mica layer; and the lower additional layer is directly attached to the lower surface of the mica layer.

According to the first aspect above, the upper additional layer is an upper reinforcement layer; and the lower additional layer is a lower reinforcement layer.

According to the first aspect above, the material of the upper additional layer has an uncured state and a cured state. When the material of the upper additional layer is in an uncured state, the material of the upper additional layer is bonded to the upper surface of the mica layer. When the material of the upper additional layer is converted to the cured state, the material of the upper additional layer forms the upper reinforcement layer. The material of the lower additional layer has an uncured state and a cured state. When the material of the lower additional layer is converted to the cured state, the material of the lower additional layer forms the lower reinforcement layer.

According to the first aspect above, the cured state of the upper additional layer and lower additional layer is a chemically crosslinked cured coating.

According to the first aspect above, the conversion of the upper additional layer and the lower additional layer from the uncured state to the cured state is initiated through radiation.

According to the first aspect above, the upper additional layer and the lower additional layer are converted from the uncured state to the cured state by heating or drying.

According to the first aspect above, the material of the upper additional layer and lower additional layer is an epoxy resin coating or a PU coating.

According to the first aspect above, the thickness of the mica layer is 0.1-3 mm.

According to the first aspect above, the thickness of the upper additional layer and lower additional layer is within 100 μm.

A second aspect of the present application provides a high-temperature-resistant insulating film comprising: an upper additional layer and an upper bonding layer; a mica layer; and a lower additional layer and a lower bonding layer; in which the outer surface of the upper additional layer forms a first outer surface of the high-temperature-resistant insulating film, and the inner surface of the upper additional layer is bonded to the upper surface of the mica layer through the upper bonding layer; and in which the inner surface of the lower additional layer is bonded to the lower surface of the mica layer through the lower bonding layer, the outer surface of the lower additional layer forms a second outer surface of the high-temperature-resistant insulating film.

According to the second aspect above, the upper additional layer and the lower additional layer are plastic films, the upper additional layer is an upper reinforcement layer; and the lower additional layer is a lower reinforcement layer.

According to the second aspect above, the upper and lower additional layers are PET films or PP films.

According to the second aspect above, the upper and lower bonding layers are glue.

According to the second aspect above, the upper additional layer is bonded to the upper surface of the mica layer through the upper bonding layer and the lower additional layer is bonded to the lower surface of the mica layer through the lower bonding layer through the lamination process.

According to the second aspect above, the thickness of the mica layer is 0.1-3 mm.

According to the second aspect above, the total thickness of the upper additional layer and the upper bonding layer and the total thickness of the lower additional layer and the lower bonding layer are both within 100 μm.

A third aspect of the present application provides a battery module comprising: a housing; several battery units disposed side-by-side in the housing; and a high-temperature-resistant insulating film positioned between two adjacent battery cells in the several battery units, or between the several battery units and the housing; in which the high-temperature-resistant insulating film is as described in any one of the first or second aspects.

### BRIEF DESCRIPTION OF THE DRAWINGS

FIG. 1A is a schematic view of the three-dimensional structure of an example of the high-temperature-resistant insulating film according to the present application;

FIG. 1B is a sectional view along line A-A of the high-temperature-resistant insulating film as shown in FIG. 1A;

FIG. 1C is a schematic view of the three-dimensional structure of another example of the high-temperature-resistant insulating film according to the present application;

FIG. 1D is a sectional view along line B-B of the high-temperature-resistant insulating film as shown in FIG. 1C;

FIG. 2A is a flow chart illustrating the production process of the high-temperature-resistant insulating film as shown in FIG. 1A;

FIG. 2B is a flow chart illustrating the production process of the high-temperature-resistant insulating film as shown in FIG. 1A;

FIG. 2C is a schematic view of a spray coating equipment;

FIG. 2D is a schematic view of a laminating equipment;

FIG. 3A is a schematic view of the three-dimensional structure of a battery module comprising the high-temperature-resistant insulating film as shown in FIG. 1A;

FIG. 3B is an exploded view of the battery module as shown in FIG. 3A.

### DETAILED DESCRIPTION

Various specific embodiments of the present application will be described below with reference to the accompanying drawings that form a part of the present specification. It should be understood that while terms denoting orientation, such as “front,” “rear,” “upper,” “lower,” “left,” “right,” “top,” “bottom,” “inside,” “outside,” etc., are used in the present application to describe various exemplary structural parts and elements of the present application, these terms are used herein for convenience of illustration only and are determined based on the exemplary orientations shown in the accompanying drawings. Since the examples disclosed in the present application may be disposed in different orientations, these terms denoting orientation are for illustrative purposes only and should not be considered as limiting.

In the present application, unless otherwise specified, all equipment and materials may be purchased from the market or are commonly used in the industry. The methods in the following examples, unless specifically stated, are conventional methods in this field.

The mica layer in the present application is formed by bonding mica paper or mica powder with an adhesive and then subjecting it to heat pressing; wherein, mica accounts for approximately 90% of the weight, and the adhesive accounts for approximately 10% of the weight. As an example, the adhesive is organic silicone glue. The mica paper or mica powder may be golden mica, white mica, or other synthetic mica. In certain examples, the mica layer is a commercially available mica sheet or mica board.

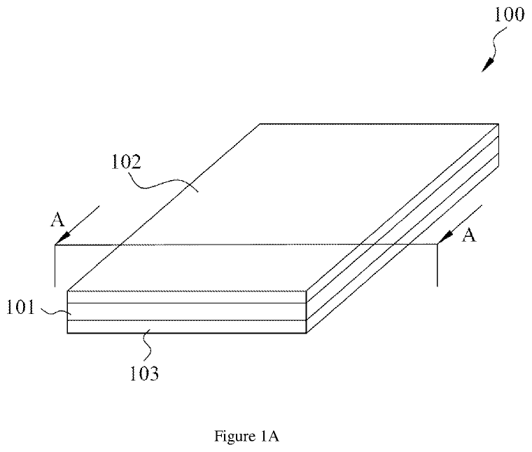

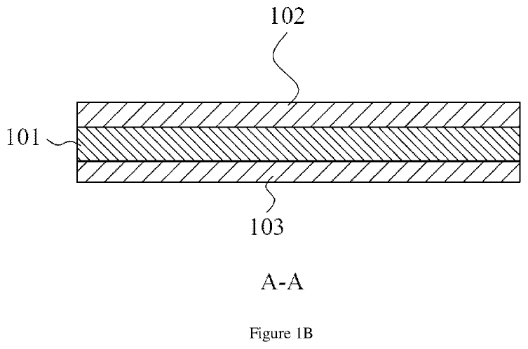

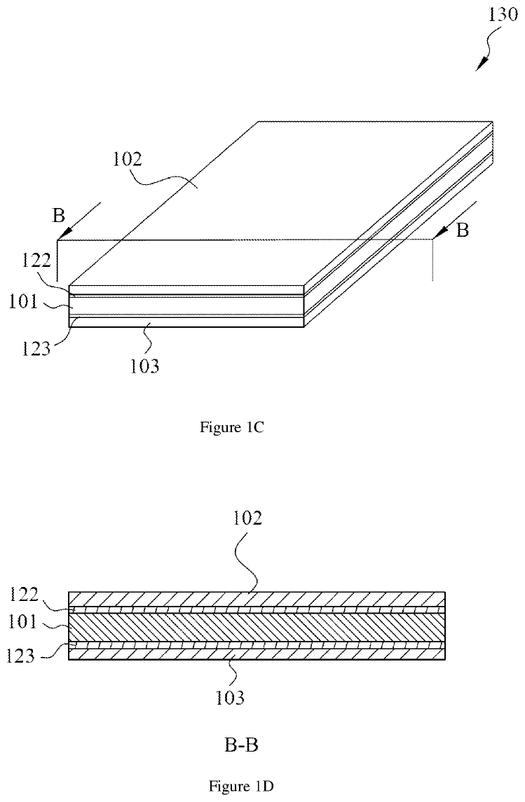

FIGS. 1A and 1B illustrate the specific structure of a high-temperature-resistant insulating film 100 according to an example of the present application. As shown in FIGS. 1A and 1B, the high-temperature-resistant insulating film 100 comprises: a mica layer 101, an upper additional layer 102, and a lower additional layer 103. As an example, the thickness of the mica layer 101 is 0.1-3 mm, and the thickness of the upper additional layer 102 and the lower additional layer 103 is within 100 μm.

The inner surface of the upper additional layer 102 is attached to the upper surface of the mica layer 101, and the outer surface of the upper additional layer 102 forms the first outer surface of the high-temperature-resistant insulating film 100 (i.e., the upper outer surface). In the example shown in FIGS. 1A and 1B, the inner surface of the upper additional layer 102 is directly attached to the upper surface of the mica layer 101. The inner surface of the lower additional layer 103 is attached to the lower surface of the mica layer 101, and the outer surface of the lower additional layer 103 forms the second outer surface of the high-temperature-resistant insulating film 100 (i.e., the lower outer surface). In the present example, the inner surface of the lower additional layer 103 is directly attached to the lower surface of the mica layer 101.

The upper additional layer 102 and the lower additional layer 103 are made of materials different from the mica layer 101. The upper additional layer 102 and the lower additional layer 103 may be made of the same material or different materials. In the present example, the upper additional layer 102 and the lower additional layer 103 are made of the same material. The material of the upper additional layer 102 and the lower additional layer 103 has an uncured state and a cured state. When the material of the upper additional layer 102 and the lower additional layer 103 is in an uncured state, they are applied and bonded to the upper surface and the lower surface of the mica layer 101, respectively. When the material of the upper additional layer 102 and the lower additional layer 103 is in a cured state, they form the upper reinforcement layer and the lower reinforcing layer, respectively. The upper reinforcement layer and the lower reinforcement layer refer to additional layers that enhance the mechanical performance of the mica layer.

The cured state of the upper additional layer 102 and the lower additional layer 103 is a chemically crosslinked cured coating. During the production process, the uncured material is first applied to the upper surface and the lower surface of the mica layer 101 through processes such as roll coating, blade coating, or spray coating; next, the uncured material is converted to the cured state to obtain the cured upper additional layer 102 and the lower additional layer 103. In some examples, the conversion of the upper additional layer 102 and the lower additional layer 103 from an uncured state to a cured state is initiated through radiation. In a specific example, the uncured material that may be cured by radiation is a commercially available UV light-curable adhesive coating with a coating thickness of 0.02-0.05 mm, and this coating may be transformed into a cured state by exposure to ultraviolet light with a wavelength of 300-370 nm and a radiation intensity of 60-120 w/cm [sic: w/cm²]. In some other examples, the conversion of the upper additional layer 102 and the lower additional layer 103 from an uncured state to a cured state is achieved through heating or drying. In a specific example, the uncured material that may be cured through heating or drying is an epoxy resin coating with a coating thickness of 0.02-0.1 mm, and this coating may be converted to a cured state through heating to 60-120 °C. In another specific example, the uncured material that may be cured through heating or drying is a PU (polyurethane) coating, and this coating may be converted to a cured state by air-drying.

FIGS. 1C and 1D illustrate the specific structure of a high-temperature-resistant insulating film 130 according to another example of the present application. As shown in FIGS. 1C and 1D, the high-temperature-resistant insulating film 130 comprises: a mica layer 101, an upper additional layer 102, and an upper bonding layer 122, as well as a lower additional layer 103 and a lower bonding layer 123. As an example, the thickness of the mica layer 101 is 0.1-3 mm, the total thickness of the upper additional layer 102 and upper bonding layer 122 is within 100 μm, and the total thickness of the lower additional layer 103 and lower bonding layer 123 is also within 100 μm. In the present example, the upper additional layer 102 and the lower additional layer 103 do not have adhesive properties; in other words, they cannot directly adhere to the upper surface and the lower surface of the mica layer 101 on their own. Meanwhile, the upper bonding layer 122 and lower bonding layer 123 do not provide reinforcement; in other words, they cannot enhance the mechanical performance of the mica layer 101.

In the example shown in FIGS. 1C and 1D, the inner surface of the upper additional layer 102 is attached to the upper surface of the mica layer 101 through the upper bonding layer 122, and the outer surface of the upper additional layer 102 forms the first outer surface of the high-temperature-resistant insulating film 130 (i.e., upper outer surface). The inner surface of the lower additional layer 103 is attached to the lower surface of the mica layer 101 through the lower bonding layer 123, and the outer surface of the lower additional layer 103 forms the second outer surface of the high-temperature-resistant insulating film 130 (i.e., lower outer surface).

The upper additional layer 102 and the lower additional layer 103 are made of materials different from the mica layer 101. The upper additional layer 102 and the lower additional layer 103 may be made of the same material or different materials. In the present example, the upper additional layer 102 and the lower additional layer 103 are made of the same material. In some examples, the upper additional layer 102 and the lower additional layer 103 are plastic films, such as PET (polyethylene terephthalate) film or PP (polypropylene) film. The upper bonding layer 122 and the lower bonding layer 123 are adhesives, such as hot-melt adhesive or thermosetting adhesive. The adhesive in the present example is hot-melt adhesive. The upper additional layer 102 and the lower additional layer 103 form the upper reinforcement layer and the lower reinforcement layer, respectively, enhancing the mechanical performance of the mica layer 101. The upper bonding layer 122 and the lower bonding layer 123 do not serve as reinforcement layers.

In the production process, specifically, hot-melt adhesive is first applied to the upper surface and the lower surface of the mica layer 101 through processes such as roll coating, blade coating, or spray coating to obtain the upper bonding layer 122 and the lower bonding layer 123, respectively: next, a plastic film is applied to each of the upper bonding layer 122 and the lower bonding layer 123; and finally, the plastic films are attached to the upper surface and the lower surface of the mica layer 101, respectively through the lamination process, forming the upper additional layer 102 and the upper bonding layer 122, as well as the lower additional layer 103 and the lower bonding layer 123. In some examples, the coating thickness of the upper bonding layer 122 and lower bonding layer 123 is 0.01-0.05 mm.

Those skilled in the art would understand that the materials for the upper additional layer 102 and lower additional layer 103 are not limited to the aforementioned examples.

The various examples of the high-temperature-resistant insulating film in the present application possess excellent high-temperature resistance, with the ability to withstand temperatures of 600-700 °C or higher. Furthermore, the high-temperature-resistant insulating film exhibits exceptional high-temperature-resistant insulation properties, maintaining its insulation even at temperatures of 600-700 °C. The high-temperature-resistant insulating film also possesses superior mechanical performance, with a tensile strength of over 100 MPa. Compared to conventional plastic-based insulating films, the high-temperature-resistant insulating film described in the present application not only offers superior heat resistance at elevated temperatures but is also cost-effective.

The applicant has observed that commercially available mica sheets or boards, due to the need for adhesive bonding and pressing during their production process, are prone to fragmentation and detachment during transportation or assembly with other components. In the application environment of certain electronic products, the fragments that fall off may adversely affect the performance stability of the electronic products and are detrimental to the environment.

In contrast, the surface of the high-temperature-resistant insulating film in the present application is no longer the mica layer but the outer surface of each additional layer, which effectively prevents the mica layer from generating fragments, and even if fragments generated, they are unlikely to fall off, thereby averting adverse impact on the performance stability of electronic products.

Furthermore, the applicant has also found that although the thickness of the upper additional layer and the lower additional layer is relatively thin compared to the mica layer, they are capable of significantly improving the mechanical performance of the mica layer. For example, the high-temperature-resistant insulating film of the present application, compared to existing mica sheets or boards, has better flexural resistance and fracture resistance. Even when the high-temperature-resistant insulating film is subjected to bending stress, it is less prone to fracturing. As a specific example, existing mica boards, after bending twice at a 60° angle, fracture and generate fragments that fall off. In contrast, the high-temperature-resistant insulating film described in the present application is capable of being repeatedly bent 7-9 times without fracturing or generating fragments that fall off.

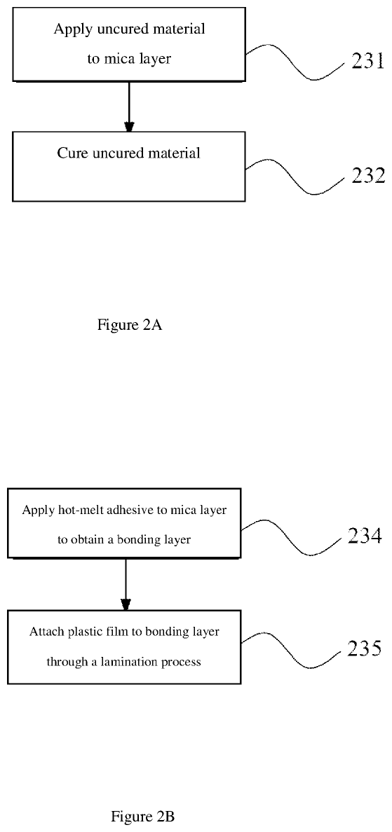

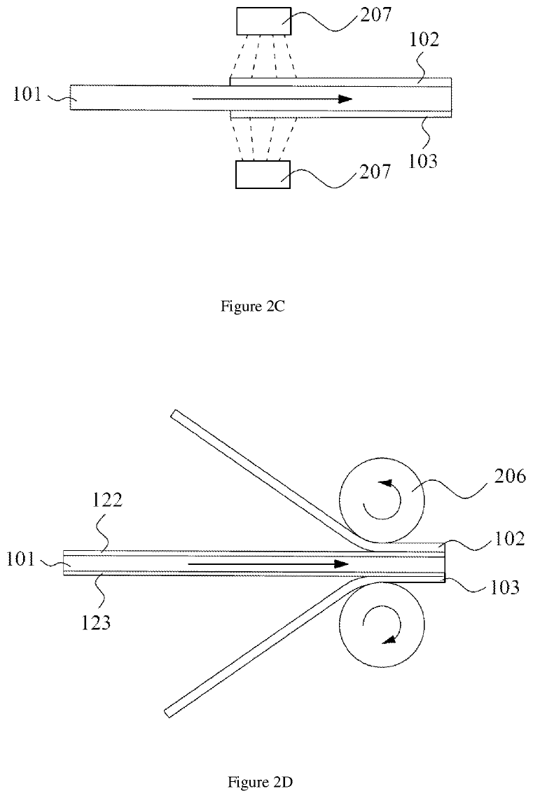

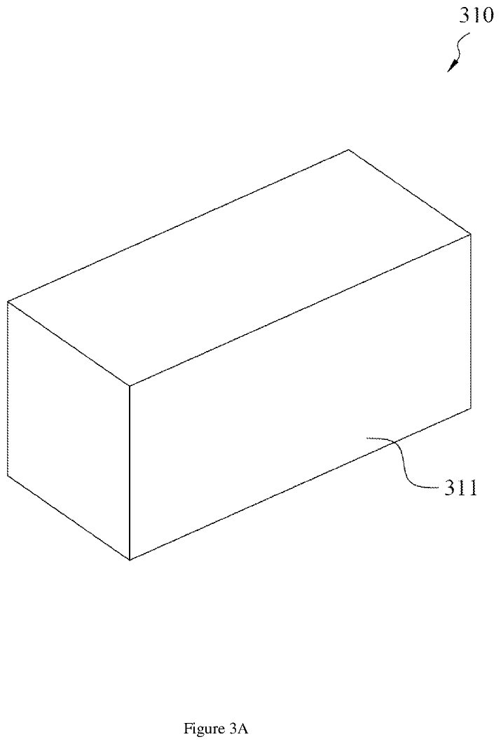

A specific description of the production method for the high-temperature-resistant insulating films 100 and 130 is provided below in conjunction with FIGS. 2A to 2D. FIG. 2A illustrates the process of the production method for the high-temperature-resistant insulating film 100. FIG. 2B illustrates the process of the production method for the high-temperature-resistant insulating film 130. FIG. 2C is a schematic view of the spray coating equipment for applying the uncured material to the upper surface and the lower surface of the mica layer 101. FIG. 2D is a schematic diagram view of the laminating equipment for pressing the plastic film onto the bonding layers 122 and 123 of the high-temperature-resistant insulating film 130.

As shown in FIGS. 2A and 2C, in step 231, the uncured material is applied to the upper surface and the lower surface of the mica layer 101 through a spray coating process. Specifically, during the production process, a pair of nozzles 207 of the spray coating equipment are fixed above and below the mica layer 101, respectively. The mica layer 101 is conveyed from left to right between the pair of nozzles 207, to apply the uncured upper additional layer 102 and lower additional layer 103 on the upper surface and the lower surface of the mica layer 101, respectively. After the spraying is completed, step 232 is initiated. In step 232, the uncured upper additional layer 102 and lower additional layer 103 are cured through methods such as radiation, heating, or drying, to obtain the high-temperature-resistant insulating film 100.

As shown in FIGS. 2B and 2D, in step 234, hot-melt adhesive is applied on the upper surface and the lower surface of the mica layer 101, to obtain the mica layer 101 coated with the upper bonding layer 122 and the lower bonding layer 123. Then, in step 235, a plastic film is attached to each of the upper bonding layer 122 and the lower bonding layer 123 through a lamination process. Specifically, during the production process, the mica layer 101 coated with the upper bonding layer 122 and the lower bonding layer 123 is conveyed from left to right between a pair of rollers 206; simultaneously, the plastic films are also conveyed through the pair of rollers 206, applying the plastic films from above the upper bonding layer 122 and below the lower bonding layer 123, respectively. The speed of application of the plastic film is 2-20 m/min. The pair of rollers 206 rotates in opposite directions, and by heating and pressing, the plastic films are connected to the corresponding bonding layers, thereby attaching the plastic films to the upper and lower surfaces of the mica layer 101, respectively. In the present example, the roller 206 above the mica layer 101 rotates counterclockwise, and the roller 206 below the mica layer 101 rotates clockwise to press the plastic films onto the upper bonding layer 122 and lower bonding layer 123, respectively. The pressure applied by the two rollers 206 on the mica layer 101 and plastic films passing between them is 3-25 MPa, and the temperature (i.e., laminating temperature) at which the mica layer 101 and plastic films pass between the two rollers 206 is controlled in the range of 95-125 °C

The high-temperature-resistant insulating film described in the present application may be utilized in various electronic products or equipment to aid in heat dissipation. Such electronic products or equipment may include electrical equipment such as battery modules, heating coils, or electric motors.

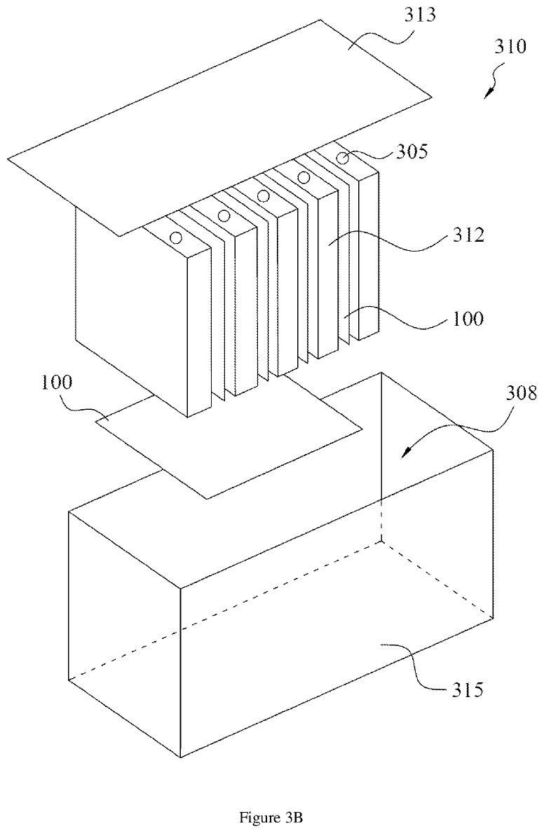

FIGS. 3A and 3B are schematic diagrams illustrating the structure of an example of a battery module comprising the high-temperature-resistant insulating film 100 of the present application, wherein FIG. 3A illustrates the overall structure of the battery module 310, while FIG. 3B illustrates the disassembled structure of the battery module 310. As shown in FIGS. 3A and 3B, battery module 310 comprises several battery units 312 and a housing 311. The housing 311 comprises a substantially square box-like body 315 and an upper lid 313, wherein the box 315 has an accommodating cavity 308, and the upper lid 313 is disposed on top of the box-like body 315 to enclose the accommodating cavity 308. A plurality of battery units 312 are housed within the accommodating cavity 308 of the box-like body 315. Each battery unit 312 has its own connecting terminal 305. After the respective connecting terminals 305 of these battery units 312 are electrically connected according to a predetermined circuit, power and/or charging is provided externally through the main connecting terminal (not shown in the figure) disposed on the housing 311.

The high-temperature-resistant insulating film 100 is positioned between adjacent battery units 312, and is also positioned between each battery unit 312 and the box-like body 105. In some examples, the high-temperature-resistant insulating film 100 is secured between adjacent battery units 312 or between each battery unit 312 and the box-like body 105 using fasteners such as bolts. In some examples, the high-temperature-resistant insulating film 100 is bonded between adjacent battery units 312 or between each battery unit 312 and the box-like body 105 using adhesive. In addition to insulating between adjacent battery units 312, the high-temperature-resistant insulating film 100 also prevents some battery units 312 from generating excessive heat and reaching high temperatures, which could lead to damage to the battery module 310 as a whole.

Furthermore, during the transportation of the battery module 310, the high-temperature-resistant insulating film 100 also provides a certain degree of support, preventing deformation due to mutual compression between the battery units 312.

If a high-temperature-resistant plastic film were used between the battery units 312, it would not only incur higher costs but also provide limited support. Moreover, even high-temperature-resistant plastic films have limited heat resistance. If the temperature of the battery unit 312 becomes too high, the plastic film may still melt or become damaged. Meanwhile, if conventional mica sheets available in the market are used between the battery units 312, although the heat resistance is improved, fragments of mica sheets are likely to fall off during transportation and installation. These fragments may fall into the box-like body 315, potentially affecting the performance of the battery module 310.

In contrast, the high-temperature-resistant insulating film described in the present application uses mica sheet as an intermediate layer, with additional layers disposed above and below the mica layer. This enhances the mechanical performance of the mica layer while retaining its high-temperature resistance. It also prevents fragments of the mica layer from falling off, making transportation and installation of the high-temperature-resistant insulating film more convenient. Moreover, this design is particularly suitable for heat dissipation and support within battery units.

Finally, the high-temperature-resistant insulating film described in the present application has numerous beneficial technical effects. Below are at least some of the technical effects of the high-temperature-resistant insulating film disclosed in the present application:
1. excellent high-temperature resistance, with the ability to withstand temperatures of 600-700 °C or higher, meeting the heat resistance requirements of electronic products and equipment.
2. superior mechanical performance with a tensile strength of over 100 MPa, and the ability to be bent repeatedly without damage, ensuring durability during transportation, packaging, and processing by manufacturers of electronic products and equipment.
3. exceptional insulation performance, especially at high temperatures, meeting the insulation requirements of electronic products and equipment.
4. simple production process.
5. convenient to use and cost-effective, with significantly lower costs compared to typical plastic films.

Although the present disclosure has been described in connection with the exemplary examples outlined above, various alternatives, modifications, variations, improvements, and/or substantial equivalents, whether known or foreseeable now or in the near future, may be apparent to those having at least ordinary skill in the art. Therefore, the exemplary examples of the present disclosure set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents. The technical effects and technical problems in this specification are exemplary and not limiting. It should be noted that the examples described in this specification may have other technical effects and may solve other technical problems.

What is claimed is:

1. A high-temperature-resistant insulating film, comprising:
an upper additional layer (102);
a mica layer (101); and
a lower additional layer (103);
in which the outer surface of the upper additional layer (102) forms a first outer surface of the high-temperature-resistant insulating film (100), and the inner surface of the upper additional layer (102) is attached to the upper surface of the mica layer (101);
and in which the inner surface of the lower additional layer (103) is attached to the lower surface of the mica layer (101) and the outer surface of the lower additional layer (103) forms a second outer surface of the high-temperature-resistant insulating film (100).

2. The high-temperature-resistant insulating film according to claim 1, wherein:
the upper additional layer (102) is directly attached to the upper surface of the mica layer (101); and
the lower additional layer (103) is directly attached to the lower surface of the mica layer (101).

3. The high-temperature-resistant insulating film according to claim 2, wherein:
the upper additional layer (102) is an upper reinforcement layer; and
the lower additional layer (103) is a lower reinforcement layer.

4. The high-temperature-resistant insulating film according to claim 3, wherein:
the material of the upper additional layer (102) has an uncured state and a cured state, the material of the upper additional layer (102) is bonded to the upper surface of the mica layer (101) when the material of the upper additional layer (102) is in the uncured state, and the material of the upper additional layer (102) forms the upper reinforcement layer when the upper additional layer (102) is converted to the cured state; and
the material of the lower additional layer (103) has an uncured state and a cured state, the material of the lower additional layer (103) is bonded to the lower surface of the mica layer (101) when the material of the lower additional layer (103) is in the uncured state, and the material of the lower additional layer (103) is a lower reinforcement layer when the lower additional layer (103) is converted to the cured state.

5. The high-temperature-resistant insulating film according to claim 4, wherein the cured state of the upper additional layer (102) and the lower additional layer (103) is a chemically crosslinked cured coating.

6. The high-temperature-resistant insulating film according to claim 5, wherein the conversion of the upper additional layer (102) and the lower additional layer (103) from the uncured state to the cured state is initiated through radiation.

7. The high-temperature-resistant insulating film according to claim 5, wherein the upper additional layer (102) and the lower additional layer (103) are converted from the uncured state to the cured state by heating or drying.

8. The high-temperature-resistant insulating film according to claim 7, wherein the material of the upper additional layer (102) and the lower additional layer (103) is an epoxy resin coating or a PU coating.

9. The high-temperature-resistant insulating film according to claim 1, wherein the thickness of the mica layer (101) is 0.1-3 mm.

10. The high-temperature-resistant insulating film according to claim 9, wherein the thickness of the upper additional layer (102) and the lower additional layer (103) is within 100 μm.

11. A high-temperature-resistant insulating film, comprising:
an upper additional layer (102) and an upper bonding layer (122);
a mica layer (101); and
a lower additional layer (103) and a lower bonding layer (123);
in which the outer surface of the upper additional layer (102) forms a first outer surface of the high-temperature-resistant insulating film (100), the inner surface of the upper additional layer (102) is bonded to the upper surface of the mica layer (101) through the upper bonding layer (122);
and in which the inner surface of the lower additional layer (103) is bonded to the lower surface of the mica layer (101) through the lower bonding layer (123), the outer surface of the lower additional layer (103) forms a second outer surface of the high-temperature-resistant insulating film (100).

12. The high-temperature-resistant insulating film according to claim 11, wherein:
the upper additional layer (102) and the lower additional layer (103) are plastic films, the upper additional layer (102) is an upper reinforcement layer; and
the lower additional layer (103) is a lower reinforcement layer.

13. The high-temperature-resistant insulating film according to claim 12, wherein the upper additional layer (102) and the lower additional layer (103) are PET films or PP films.

14. The high-temperature-resistant insulating film according to claim 11, wherein the upper bonding layer (122) and the lower bonding layer (123) are hot-melt adhesives.

15. The high-temperature-resistant insulating film according to claim 11, wherein the upper additional layer (102) is bonded to the upper surface of the mica layer (101) through the upper bonding layer (122) and the lower additional layer (103) is bonded to the lower surface of the mica layer (101) through the lower bonding layer (123) through the lamination process.

16. The high-temperature-resistant insulating film according to claim 11, wherein the thickness of the mica layer (101) is 0.1-3 mm.

17. The high-temperature-resistant insulating film according to claim 11, wherein the total thickness of the upper additional layer (102) and the upper bonding layer (122), and the total thickness of the lower additional layer (103) and the lower bonding layer (123) are both within 100 μm.

18. A battery module, comprising:
a housing (311);
several battery units (312) disposed side-by-side in the housing (311); and
a high-temperature-resistant insulating film (100) positioned between two adjacent battery units (312) in the several battery units (312), or between the several battery units (312) and the housing (311);
in which the high-temperature-resistant insulating film (100) is according to any one of claims 1-17.
